(19) United States
(12) Patent Application Publication
(10) Pub. No.: US 2008/0225171 A1
(43) Pub. Date: Sep. 18, 2008

(54) DISPLAY SYSTEM FOR VIDEO STREAM AND METHOD THEREOF

(76) Inventor: Hsuan-Huei Shih, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/685,205

(22) Filed: Mar. 13, 2007

(51) Int. Cl. H04N 5/45

(52) U.S. Cl. 348/565; 348/E05.112

(57) ABSTRACT

The present invention discloses a display method for a video stream including video contents of a plurality of channels, the display method includes: displaying video contents transmitted by a first channel on a first portion of a display screen, wherein the first channel is not a currently tuned channel; displaying video contents transmitted by a second channel on a second portion of the display screen, wherein the second channel is the currently tuned channel; and when the video contents of the first channel are being displayed on the first portion of the display screen and the currently tuned channel is switched from the second channel into a third channel, displaying video contents transmitted by the third channel on the second portion of the display screen.

### BACKGROUND OF THE INVENTION

1. Field of the Invention

The present invention relates to a display system, and more particularly to a display system for displaying a video stream including video contents of a plurality of channels at the same time, and a method thereof.

2. Description of the Prior Art

Nowadays, digital television systems are able to provide a wide variety of channels for a viewer. The viewer may wish to watch two broadcast programs at the same time, therefore the well-known picture-in-picture (PIP) and picture-outside-picture (POP) techniques can be utilized to satisfy such a requirement.

Picture-in-picture/picture-outside-picture (PIP/POP) is a popular function for display devices having large dimensions, such as LCD TVs, PDP TVs etc. There are different modes of PIP/POP viewing, such as single PIP (SP), dual PIP (DP) and twin view/twin PIP. However, the operation of displaying two broadcasting programs through PIP and POP techniques is both complicated and inconvenient.

For example, when a first broadcasting program of a currently tuned channel is enjoyed by the viewer, and the viewer wishes to enjoy a second broadcasting program of another channel at the same time, then the viewer needs to press a button on the controller of the digital television to enter the PIP/POP mode. After that, the viewer needs to enter the channel numbers corresponding to the first and second broadcasting programs into the digital television system. Finally, the viewer may need to press another button on the controller to display the first and second broadcasting programs simultaneously on the displaying apparatus. Furthermore, if the viewer wishes to enjoy another broadcasting program utilizing the PIP/POP mode, the same setting process should be repeated. Accordingly, a more simple controlling method of switching between a plurality of channels in the PIP/POP mode of a digital television system needs to be developed.

### SUMMARY OF THE INVENTION

Therefore, one of the objectives of the present invention is to provide a display system for displaying a video stream including video contents of a plurality of channels at the same time, and a method thereof.

According to an embodiment of the present invention, a display method for a video stream including video contents of a plurality of channels is disclosed. The display method comprises: displaying video contents transmitted by a first channel on a first portion of a display screen, wherein the first channel is not a currently tuned channel; displaying video contents transmitted by a second channel on a second portion of the display screen, wherein the second channel is the currently tuned channel; and when the video contents of the first channel are being displayed on the first portion of the display screen and the currently tuned channel is switched from the second channel into a third channel, displaying video contents transmitted by the third channel on the second portion of the display screen.

According to a second embodiment of the present invention, a display system for a video stream including video contents of a plurality of channels is disclosed. The display system comprises a channel selector, a display device, and a display controller. The channel selector is coupled to the video stream for selecting a first channel and a second channel from the channels in a multi-picture display mode of the display system, wherein the first channel is not a currently tuned channel, and the second channel is the currently tuned channel. The display device is for displaying video contents transmitted by the first channel and the second channel on a first portion of a display screen of the display device and a second portion of the display screen respectively when in the multi-picture display mode of the display system. The display controller is coupled to the channel selector and the display device for driving the display device according to outputs of the channel selector, wherein when the video contents of the first channel are being displayed on the first portion of the display screen and the channel selector switches the currently tuned channel from the second channel into a third channel in the multi-picture display mode of the display system, the display controller controls the display device to display video contents transmitted by the third channel on the second portion of the display screen.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display system for a video stream including video contents of a plurality of channels.

FIG. 2 is a diagram illustrating the display screen of the display system shown in FIG. 1.

FIG. 3 is a diagram illustrating channel switching between the multi-picture display mode and the normal display mode of the display system shown in FIG. 1.

FIG. 4 is a flowchart illustrating a display method for the video stream including video contents of the plurality of channels according to another embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

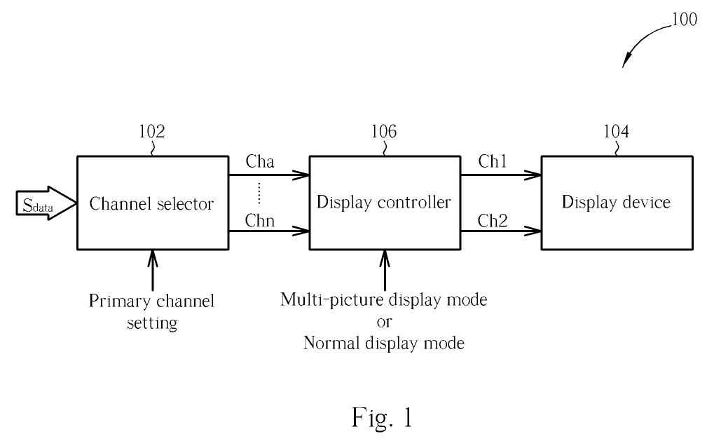

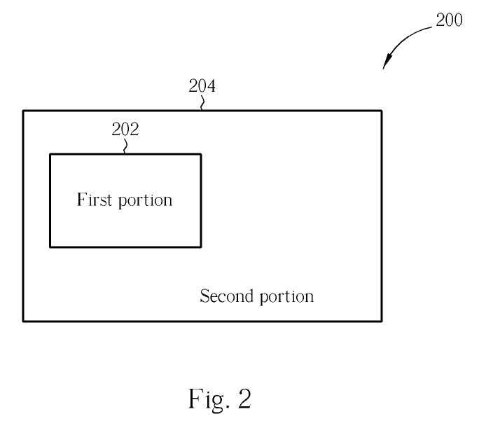

Please refer to FIG. 1. FIG. 1 is a diagram illustrating a display system 100 for a video stream S_{data} including video contents of a plurality of channels Cha˜Chn, the display system 100 comprising a channel selector 102, a display device 104, and a display controller 106. Please note that the display system 100 can be operated in a multi-picture display mode or a normal display mode, which is controlled by the display controller 106. Furthermore, for brevity, the channels Cha˜Chn are TV channels, but this is not a limitation of the present invention. In other words, the channels Cha˜Chn can also include TV channels and other channels outputted by other digital apparatus. The channel selector 102 is coupled to the video stream S_{data} for selecting a first channel Ch1 and a second channel Ch2 from the channels Cha˜Chn in the multi-picture display mode of the display system 100. Please note that, in order to clearly describe the spirit of the present invention, the first channel Ch1 is not a currently tuned channel, and the second channel Ch2 is the currently tuned channel in the multi-picture display mode of this embodiment. Furthermore, in this embodiment, the display device 104 controls a display screen 200 shown in FIG. 2. FIG. 2 is a diagram illustrating the display screen 200 of the display system 100 as shown in FIG. 1. The display screen 200 comprises a first portion 202 and a second portion 204 for displaying video contents S_{data1} and video contents S_{data2} corresponding to the first channel Ch1 and the second channel Ch2 respectively. Therefore, the display device 104 is utilized for displaying video contents S_{data1} transmitted by the first channel Ch1 on the first portion 202 of the display screen 200 and displaying video contents S_{data2} transmitted by the second channel Ch2 on the second portion 204 of the display screen 200 in the multi-picture display mode of the display system 100. The display controller 106 is coupled to the channel selector 102 and the display device 104 for driving the display device 104 according to outputs of the channel selector 102. Please note that a size of the first portion 202 on the display screen 200 is smaller than a size of the second portion 204 on the display screen 200, and the first portion 202 is overlaid on the second portion 204, however, this is not a limitation of the present invention. In other words, the size of the first portion 202 can be larger than the size of the second portion 204 on the display screen 200. Furthermore, those skilled in this art will know that one implementation of the display screen 200 is to utilize the technique of picture-in-picture (PIP) or split screen, therefore a detailed description of this operation is omitted here for brevity.

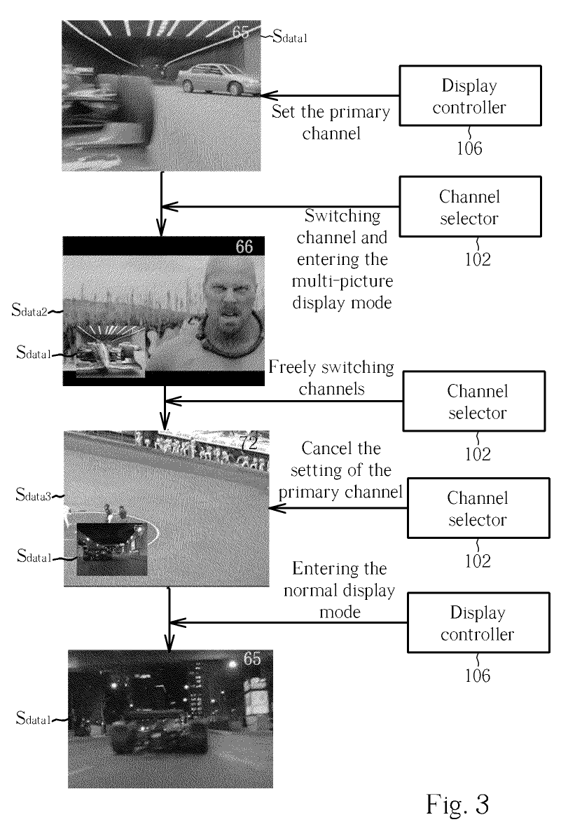

Please refer to FIG. 3. FIG. 3 is a diagram illustrating channel switching between the multi-picture display mode and the normal display mode of the display system 100. In order to describe the spirit of the present invention more clearly, the display system 100 initially operates in the normal display mode as shown in FIG. 3. In the normal display mode of the display system 100, the display controller 106 sets the first channel Ch1 (i.e. channel 65) to be a primary channel and controls the display device 104 to display video contents (i.e. a car racing program) of the primary channel on the display screen 200. Accordingly, the video contents of the first channel Ch1 is displayed on the full screen of the display screen 200. When the channel selector 102 switches from the primary channel to the second channel Ch2 (i.e. channel 66), the display system 100 enters the multi-picture display mode, in which the video contents correspond to the second channel Ch2, which is a movie program.

According to the present invention, when the display system 100 enters the multi-picture display mode, the display controller 106 controls the display device 104 to display the car racing program on channel 65 (displayed on the full screen of the display screen 200 in the normal display mode) on the first portion 202 of the display screen 200. At the same time, the display controller 106 controls the display device 104 to display the movie program on channel 66 on the second portion 204 of the display screen 200 as shown in FIG. 3. Then, according to the embodiment of the present invention, the car racing program on channel 65 can be enjoyed through the first portion 202 of the display screen 200 while the movie program on channel 66 can also be enjoyed through the second portion 204 of the display screen 200. Furthermore, according to the embodiment of the present invention, when the channel selector 102 switches the currently tuned channel, which is channel 66, into a third channel Ch3 (i.e. the channel 72) in the multi-picture display mode of the display system 100, the display controller 106 controls the display device 104 to display video contents S_{data3} (i.e. a sports program) transmitted by the channel 72 on the second portion 204 of the display screen 200. In other words, a user of the display system 100 can freely enjoy any video contents transmitted by any channels apart from channel 65 on the second portion 204 of the display screen 200 in the multi-picture display mode.

On the other hand, according to the embodiment of the present invention, the user is allowed to cancel the setting of channel 65 as the primary channel in the multi-picture display mode at any time. Please refer to FIG. 3 again. When the primary channel setting for channel 65 is cancelled in the multi-picture display mode through the channel selector 102, the display system 100 exits the multi-picture display mode and enters the normal display mode to display video contents of channel 65 (i.e. the car racing program) in the full screen of the display screen 200. Please note that, in another situation in the multi-picture display mode of the display screen 200, the user may control the channel selector 102 to switch the currently tuned channel of channel 66 back to the primary channel of channel 65, then the display system 100 exits the multi-picture display mode and enters the normal display mode to display video contents of the primary channel, i.e. the car racing program of the channel 65.

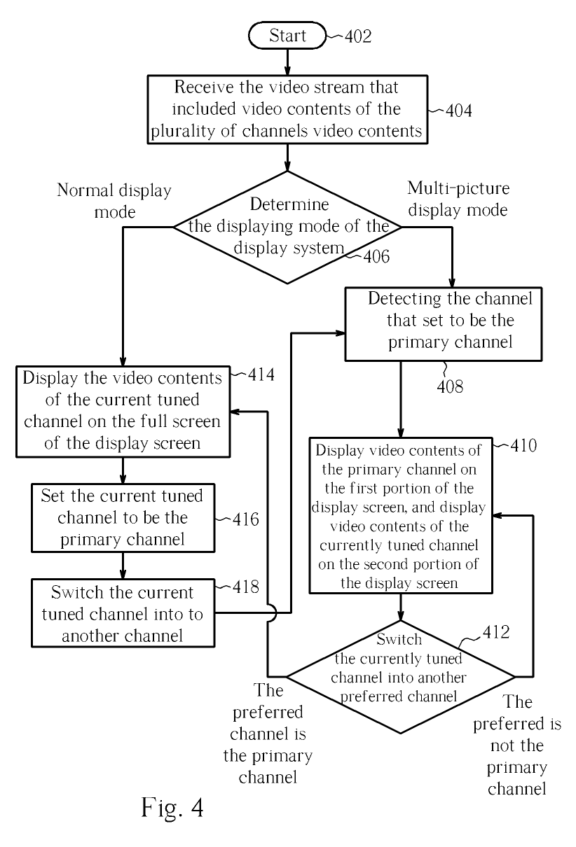

Please refer to FIG. 4. FIG. 4 is a flowchart illustrating a display method for the video stream including video contents of the plurality of channels Cha˜Chn according to another embodiment of the present invention. Please note that, for brevity, the display method is implemented by the display system 100 as shown in FIG. 1, and the display method comprises the following steps:

Step 402: Start;

Step 404: Receive the video stream S_{data} that includes video contents of the plurality of channels Cha˜Chn;

Step 406: Determine the displaying mode of the display system 100, if the displaying mode is the multi-picture mode, go to step 408; if the displaying mode is the normal display mode, go to step 414;

Step 408: Detect the channel (i.e. channel 65) that is set to be the primary channel;

Step 410: Display video contents (i.e. a car racing program) of the primary channel on the first portion 202 of the display screen 200, and display video contents (i.e. a movie program) of the currently tuned channel (i.e. the channel 66) on the second portion 204 of the display screen 200;

Step 412: Switch the currently tuned channel into another preferred channel; if the preferred channel is the primary channel (i.e. channel 65), go to step 414; if the preferred channel is not the primary channel, go to step 410;

Step 414: Display the video contents of the current tuned channel on the full screen of the display screen 200;

Step 416: Set the current tuned channel to be the primary channel;

Step 418: Switch the current tuned channel to another channel; go to step 408.

In step 410, the size of the first portion 202 on the display screen 200 is smaller than the size of the second portion 204 on the display screen 200, and the first portion 202 is overlaid on the second portion 204, however, this is not a limitation of the present invention. In other words, the size of the first portion 202 can be larger than the size of the second portion 204 on the display screen 200. Furthermore, those skilled in this art will know that one of the implementations of the display screen 200 is to utilize the technique of picture-in-picture (PIP) or split screen, therefore a related detailed description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display method for a video stream including video contents of a plurality of channels, the display method comprising:
(a) displaying video contents transmitted by a first channel on a first portion of a display screen, wherein the first channel is not a currently tuned channel;
(b) displaying video contents transmitted by a second channel on a second portion of the display screen, wherein the second channel is the currently tuned channel; and
(c) when the video contents of the first channel are being displayed on the first portion of the display screen and the currently tuned channel is switched from the second channel into a third channel, displaying video contents transmitted by the third channel on the second portion of the display screen.

2. The display method of claim 1, further comprising:
in a normal display mode, setting the first channel to be a primary channel and displaying video contents of the primary channel on the display screen; and
when switching from the primary channel into the second channel, entering a multi-picture display mode for performing steps (a), (b), and (c).

3. The display method of claim 1, wherein a size of the first portion on the display screen is smaller than a size of the second portion on the display screen, and the first portion is overlaid on the second portion.

4. The display method of claim 1, wherein a size of the second portion on the display screen is smaller than a size of the first portion on the display screen, and the second portion is overlaid on the first portion.

5. The display method of claim 2, further comprising:
when the currently tuned channel is switched into the first channel in the multi-picture display mode, exiting the multi-picture display mode and entering the normal display mode to display video contents of the primary channel.

6. The display method of claim 2, further comprising:
when a setting of the primary channel is cancelled in the multi-picture display mode, exiting the multi-picture display mode and entering the normal display mode to display video contents of the first channel.

7. The display method of claim 1, wherein the channels are TV channels.

8. A display system for a video stream including video contents of a plurality of channels, the display system comprising:
a channel selector, coupled to the video stream, for selecting a first channel and a second channel from the plurality of channels in a multi-picture display mode of the display system, wherein the first channel is not a currently tuned channel, and the second channel is the currently tuned channel;
a display device, for displaying video contents transmitted by the first channel on a first portion of a display screen of the display device and displaying video contents transmitted by the second channel on a second portion of the display screen in the multi-picture display mode of the display system; and
a display controller, coupled to the channel selector and the display device, for driving the display device according to outputs of the channel selector, wherein when the video contents of the first channel are being displayed on the first portion of the display screen and the channel selector switches the currently tuned channel from the second channel into a third channel in the multi-picture display mode of the display system, the display controller controls the display device to display video contents transmitted by the third channel on the second portion of the display screen.

9. The display system of claim 8, wherein in a normal display mode of the display system, the display controller sets the first channel to be a primary channel and controls the display device to display video contents of the primary channel on the display screen; and when the channel selector switches from the primary channel into the second channel, the display system enters the multi-picture display mode.

10. The display system of claim 8, wherein a size of the first portion on the display screen is smaller than a size of the second portion on the display screen, and the first portion is overlaid on the second portion.

11. The display system of claim 8, wherein a size of the second portion on the display screen is smaller than a size of the first portion on the display screen, and the second portion is overlaid on the first portion.

12. The display system of claim 9, wherein in multi-picture display mode of the display system, when the channel selector switches the currently tuned channel into the first channel, the display system exits the multi-picture display mode and enters the normal display mode to display video contents of the primary channel.

13. The display system of claim 9, wherein when the display controller cancels the setting of the primary channel in the multi-picture display mode, the display system exits the multi-picture display mode and enters the normal display mode to display video contents of the first channel.

14. The display system of claim 8, wherein the channels are TV channels.
